(19) United States
(12) Patent Application Publication
(10) Pub. No.: US 2021/0342341 A1
(43) Pub. Date: Nov. 4, 2021

(54) DATA ANALYSIS ASSISTANCE DEVICE, DATA ANALYSIS ASSISTANCE METHOD, AND DATA ANALYSIS ASSISTANCE PROGRAM

(71) Applicant: DOTDATA, INC., San Mateo, CA (US)

(72) Inventors: Ryohei Fujimaki, San Mateo, CA (US); Yukitaka Kusumura, San Mateo, CA (US); Yusuke Muraoka, San Mateo, CA (US)

(21) Appl. No.: 16/956,531

(22) PCT Filed: Jul. 26, 2018
(86) PCT No.: PCT/JP2018/028082

§ 371 Date: Jun. 19, 2020

Related U.S. Application Data
(60) Provisional application No. 62/609,768, filed on Dec. 22, 2017.

(51) Int. Cl. G06F 16/2455; G06F 16/28

(52) U.S. Cl. CPC G06F 16/2455; G06F 16/284

(57) ABSTRACT

An analysis process receiving unit 182 receives creation of an analysis process which is a series of processing operations for analyzing data using a column name defined by a schema to be applied to a table. A schema/analysis process storing unit 183 stores information in which the received analysis process is associated with a schema that can be applied to the analysis process. When selection of a table has been received from the user, an analysis process retrieval unit 184 outputs a list of tables used by the received analysis process on the basis of information stored in a table/schema storing unit and information stored in a schema/analysis process storing unit 183. An analysis process executing unit 185 receives selection of an analysis process from the outputted list, and executes the selected analysis process on the received table.

### TECHNICAL FIELD

The present invention relates to a data analysis assisting device, a data analysis assisting method, and a data analysis assisting program for assisting with the analysis of data using a relational database.

### BACKGROUND ART

Various types of analysis are performed using existing data. Relational databases (RDB below) in particular are often used, and various data processing methods using RDB have been proposed.

For example, Patent Document 1 describes the generation of feature candidates used in machine learning from data managed using RDB. In the method described in Patent Document 1, the processing performed to generate feature candidates is defined using combinations of three conditions, namely, a filter condition, map condition, and reduction condition, to reduce the number of hours of labor that analysts must perform to generate feature candidates.

### PRIOR ART DOCUMENTS

### Patent Documents

Patent Document 1: WO 2017/090475 A1

### SUMMARY OF THE INVENTION

### Problem to be Solved by the Invention

In RDB, schemas and tables have a one-to-one correspondence, and data analysis processing is written for each table. In other words, different analysis processing is written for data in each table when tables are different, even when the tables have the same structure.

Information expressing the same content is sometimes managed using a plurality of tables defined by the same schema in order to improve retrieval process performance and manage distributed data. However, in such an environment, different analysis processing has to be written for each table even when the same analysis processing is to be written for information representing the same content.

For example, in the method described in Patent Document 1, when the tables to be analyzed are different, the details of the conditions to be described and the details of the feature generating function to be generated are different. However, writing different analysis processing for different tables containing the same content is complicated. Therefore, it would be preferable to use analysis processing defined by the data in a table on another table with the same structure.

Therefore, it is an object of the present invention to provide a data analysis assisting device, a data analysis assisting method, and a data analysis assisting process that are able to execute an analysis process defined for one table on a different table.

### Means for Solving the Problem

The present invention is a data analysis assisting device comprising: an analysis process receiving unit for receiving creation of an analysis process which is a series of processing operations for analyzing data using a column name defined by a schema to be applied to a table; a schema/analysis process storing unit for storing information in which the received analysis process has been associated with a schema that can be applied to the received analysis process; an analysis process retrieval unit for identifying analysis processes that can be applied to a received table on the basis of information stored in a table/schema storing unit for storing information in which a table has been associated with a schema to be applied to the table, and information stored in a schema/analysis process storing unit when selection of a table has been received from the user, and then outputting a list of analysis processes; and an analysis process executing unit for receiving selection of an analysis process from the outputted list, and executing the selected analysis process on the received table.

The present invention is also a data analysis assisting method comprising: receiving creation of an analysis process which is a series of processing operations for analyzing data using a column name defined by a schema to be applied to a table; storing information in which the received analysis process has been associated with a schema that can be applied to the received analysis process in a schema/analysis process storing unit; identifying analysis processes that can be applied to a received table on the basis of information stored in a table/schema storing unit for storing information in which a table has been associated with a schema to be applied to the table, and information stored in a schema/analysis process storing unit when selection of a table has been received from the user; outputting a list of analysis processes; receiving selection of an analysis process from the outputted list; and executing the selected analysis process on the received table.

The present invention is also a data analysis assisting device program causing a computer to execute: an analysis process receiving process for receiving creation of an analysis process which is a series of processing operations for analyzing data using a column name defined by a schema to be applied to a table, and registering, in a schema/analysis process storing unit, information in which the received analysis process has been associated with a schema that can be applied to the received analysis process; an analysis process retrieving process for identifying analysis processes that can be applied to a received table on the basis of information stored in a table/schema storing unit for storing information in which a table has been associated with a schema to be applied to the table, and information stored in a schema/analysis process storing unit when selection of a table has been received from the user, and then outputting a list of analysis processes; and an analysis process executing process for receiving selection of an analysis process from the outputted list of analysis processes, and executing the selected analysis process on the received table.

### Effects of the Invention

The present invention is able to execute an analysis process defined for one table on a different table.

### BRIEF DESCRIPTION OF THE DRAWINGS

FIG. 1 is a block diagram showing an example of a configuration for the data analysis assisting device in a first embodiment of the present invention.

FIG. 2 is a diagram used to explain an example of processing in which a schema is extracted from a table with schema.

FIG. 3 is a diagram used to explain an example of information stored by the table schema management DB 30.

FIG. 4 is a diagram used to explain an example of processing in which an analysis process is created.

FIG. 5 is a diagram used to explain an example of information in which an analysis process is associated with a schema that can be applied to the analysis process.

FIG. 6 is a diagram used to explain an example of processing in which an analysis process is outputted.

FIG. 7 is a diagram used to explain an example of processing in which an analysis process is executed.

FIG. 8 is a diagram used to explain an example of processing in which a table is outputted.

FIG. 9 is a flowchart showing an example of operations for executing an analysis process using the data analysis assisting device in the first embodiment.

FIG. 10 is a flowchart showing another example of operations for executing an analysis process using the data analysis assisting device in the first embodiment.

FIG. 11 is a flowchart showing an example of operations for managing a schema.

FIG. 12 is a block diagram showing an example of a configuration for the data analysis assisting device in a second embodiment of the present invention.

FIG. 13 is a diagram used to explain an example in which an analysis data type is set in response to the contents of a column.

FIG. 14 is a diagram used to explain an example of processing in which an analysis schema is extracted.

FIG. 15 is a flowchart showing an example of operations for managing a schema.

FIG. 16 is a block diagram providing an overview of the data analysis assisting device of the present invention.

### EMBODIMENT OF THE INVENTION

The following is a description of embodiments of the present invention with reference to the drawings. In the following description, a table refers to a tabular dataset (tabular information), and a table integrated with a schema (that is, a table associated with a schema) is referred to as a table with schema. A schema in the present invention is information defining the attributes of a table (fields, columns). Examples of attributes include the column names, data types, and restrictions in a table.

### 1st Embodiment

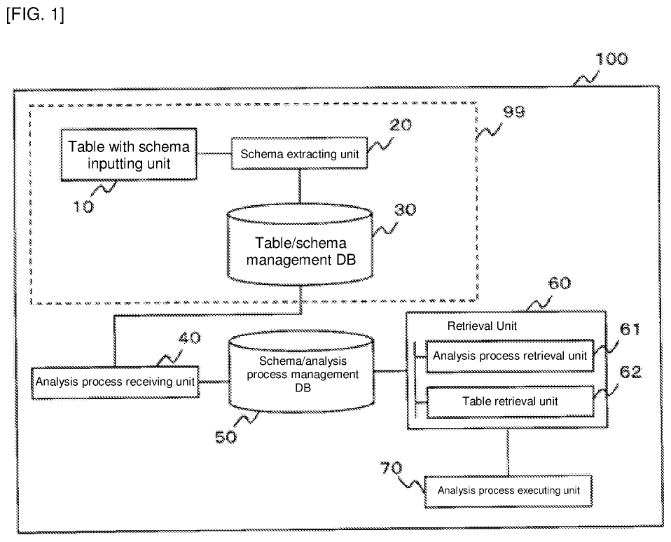

FIG. 1 is a block diagram showing an example of a configuration for the data analysis assisting device in a first embodiment of the present invention. The data analysis assisting device 100 in the present embodiment includes a table with schema inputting unit 10, a schema extracting unit 20, a table/schema managing database 30 (table/schema management DB 30 below), an analysis process receiving unit 40, a schema/analysis process managing database 50 (schema/analysis process management DB 50), a retrieval unit 60, and an analysis process executing unit 70.

Note that the table/schema management DB 30 and the schema/analysis process management DB 50 are specifically stored in, for example, a magnetic disk device.

The table with schema inputting unit 10 inputs tables with schema. The table with schema inputting unit 10 may, for example, input tables with schema directly from RDB via an interface for providing RDB. The table with schema inputting unit 10 may also read files associated with the content of schemas and tables.

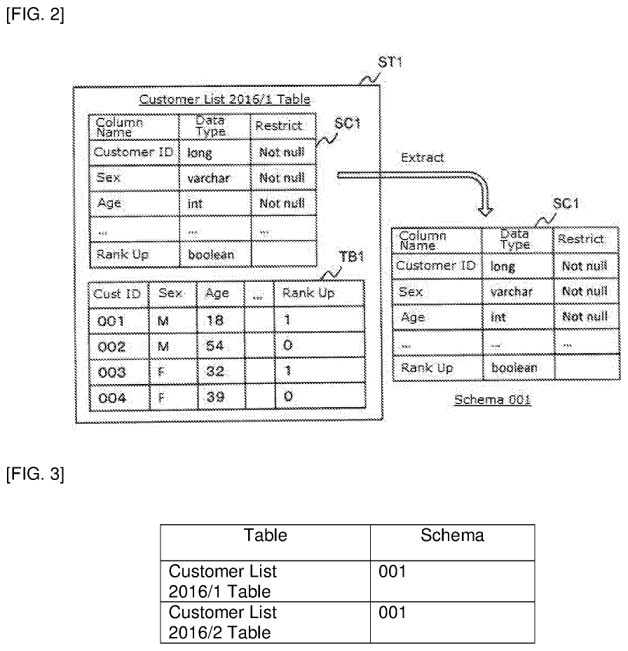

The schema extracting unit 20 extracts schema from tables with schema, associates the extracted schema with a table, and registers the association in the table/schema management DB 30. FIG. 2 is a diagram used to explain an example of processing in which a schema is extracted from a table with schema. The table with schema ST1 shown in FIG. 2 is a table with schema representing a customer list for January 2016, and includes schema SC1 and table TB1 which is tabular information.

The table with schema inputting unit 10 inputs the table with schema ST1 shown in FIG. 2. At this time, the schema extracting unit 20 extracts schema SC1 including column names, data types, and restrictions, from table with schema ST1. However, the information in a schema extracted by the schema extracting unit 20 is not limited to the information shown in FIG. 2. The schema extracting unit 20 may extract schemas including information representing other tabular attributes.

When registering a schema in the table/schema management DB 30, the schema extracting unit 20 registers the extracted schema as a new schema in the table/schema management DB 30 if a schema with matching column names and data types has not been registered. The schema extracting unit 20 may also register the extracted schema as a new schema in the table/schema management DB 30 if a schema with matching restrictions in addition to column names and data types has not been registered.

The schema extracting unit 20 sets an identifier for identifying the schema. In the example shown in FIG. 2, the serial number “001” is set as the identifier for schema SC1. Note that schema identifiers are not limited to numerical values as shown in FIG. 2. The schema extracting unit 20 may receive a schema name (for example, “customer list”) indicated by the client and use what is indicated as the schema name.

The table/schema management DB 30 associates schemas with tables and stores the association. For example, the table/schema management DB 30 may associate a schema name with a table name and store the association.

FIG. 3 is a diagram used to explain an example of information stored by the table schema management DB 30. In the example shown in FIG. 3, the table/schema management DB 30 associates schema names with table names and stores the associations. In the example shown in FIG. 3, the same schema (schema 001) is applied to both the January 2016 customer list (Customer List 2016/1 Table) and the February 2016 customer list (Customer List 2016/2 Table).

Note that because tables and schemas can be managed separately by the table with schema inputting unit 10, the schema extracting unit 20, and the table/schema management DB 30, the device 99 including the table with schema inputting unit 10, the schema extracting unit 20, and the table/schema management DB 30 can be referred to as the schema managing device. In the present embodiment, the data analysis supporting device 100 includes a schema managing device. However, the data analysis supporting device 100 does not have to include a schema managing device. For example, an external data analysis device may be used, and the data analysis supporting device 100 may connect to the external data analysis device to obtain information.

The analysis process receiving unit 40 receives the creation of an analysis process using a column name defined by a schema. An analysis system process is a series of processing operations performed on data in a table. In the present embodiment, the analysis process is created based on a schema separate from tables. The analysis process receiving unit 40 may receive a previously created analysis process or may receive an analysis process created based on user input on a screen for creating an analysis process.

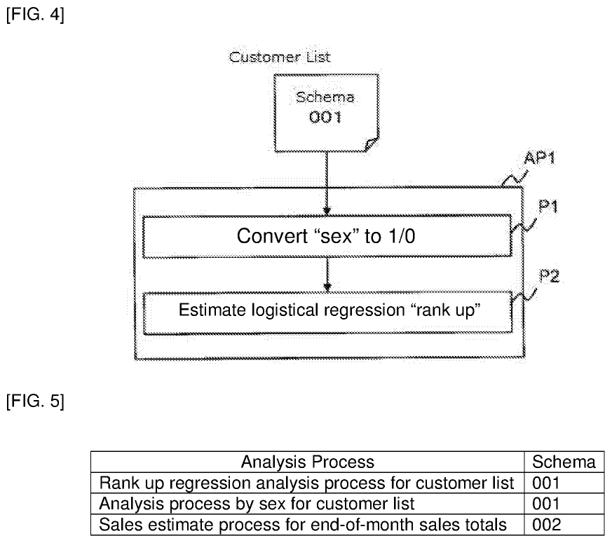

FIG. 4 is a diagram used to explain an example of processing in which an analysis process is created. For example, an analysis process performed based on content in a client list to determine whether or not each client has ranked up (rank up regression analysis) may be created. In the example shown in FIG. 4, an analysis is performed using data from a table to which the schema SC1 (schema 001) shown in FIG. 2 has been applied.

For example, the input data in machine learning has to be numerical data. In the example shown in FIG. 2, the sex data type is varchar type data, and the data content is represented by M or F. Therefore, the analysis process receiving unit 40 may create process P1 for converting the sex data in schema 001 (for example, a process for converting M to 1 and F to 0). The analysis process receiving unit 40 may also create a determination process P2 for determining whether ranking up has occurred based on user attributes using a regression formula (for example, logit (rank up)=age×3+sex+1). The analysis process receiving unit 40 then receives a created series of processing operations as analysis process AP1.

The analysis process receiving unit 40 registers the created analysis process in a schema/analysis process management DB 50. The analysis process receiving unit 40 may give the analysis process a name so that the content can be grasped and register it in the schema/analysis process management DB 50 as well. For example, in the example shown in FIG. 4, the analysis process receiving unit 40 may give the analysis process the name “rank up regression analysis process for client lists” and register this name in the schema/analysis process management DB 50.

If the analysis process is in a format enabling the analysis process executing unit 70 described below to execute it, then any method can be used to express the analysis process. For example, an analysis process may be expressed using the script format.

As mentioned above, the analysis process receiving unit 40 receives the creation not of an analysis process including table definition but an analysis process using column names defined by a schema. As a result, an analysis process with the same content can be reused when the table to be processed is different but the schema is the same.

The schema/analysis process management DB 50 stores information in which an analysis process is associated with a schema that can be applied to the analysis process. FIG. 5 is a diagram used to explain an example of information in which an analysis process is associated with a schema that can be applied to the analysis process. For example, the analysis process shown in FIG. 4 is defined using schema 001, and can be said to be a process to which schema 001 applies. Therefore, schema/analysis process management DB 50 associates an analysis process in FIG. 4 to schema 001, as shown in the first line of the table in FIG. 5, and stores the association.

The retrieval unit 60 retrieves a selection from the user, retrieves each type of information, and outputs the information. The retrieval unit 60 includes an analysis process retrieval unit 61 and a table retrieval unit 62.

The analysis process retrieval unit 61 receives a table selection from the user. The analysis process retrieval unit 61 then extracts the schema associated with the received table from information stored in the table/schema management DB 30. Next, the analysis process retrieval unit 61 identifies and outputs the analysis process associated with the extracted schema from information stored in the schema/analysis process management DB 50.

The table retrieval unit 62 receives an analysis process selection from the user. The table retrieval unit 62 then extracts the schema associated with the received analysis process from information stored in the schema/analysis process management DB 50. Next, the table retrieval unit 62 identifies and outputs the table associated with the extracted schema from information stored in the table/schema management DB 30.

The analysis process executing unit 70 executes the analysis process on the selected table. The following is an explanation of two methods that can be used by the analysis process executing unit 70 to execute the analysis process.

The retrieval unit 60 (specifically the analysis process retrieval unit 61) outputs an analysis process when a table selection has been received from the user. At this time, the analysis process executing unit 70 receives selection of the analysis process desired by the user from an outputted list of analysis processes. The analysis process executing unit 70 then executes the analysis process selected for the received table.

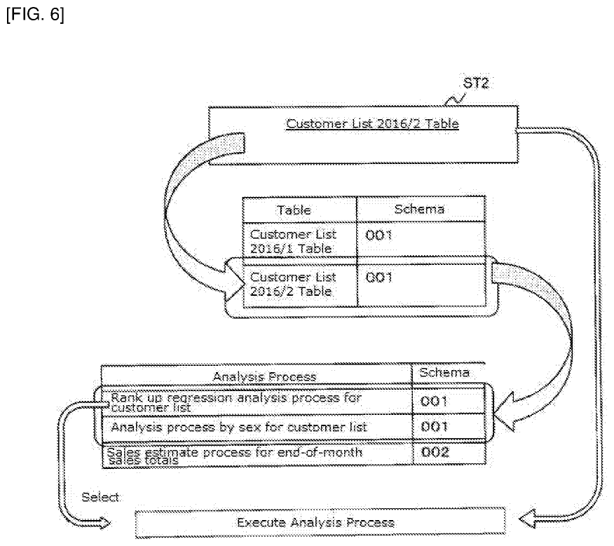

FIG. 6 is a diagram used to explain an example of processing in which an analysis process is outputted. When the retrieval unit 60 receives selection of table with schema ST2 in FIG. 6 representing the February 2016 customer list from the user, the analysis process retrieval unit 61 extracts schema 001 associated with the received table from information stored in the table/schema management DB 30 shown in FIG. 3. The analysis process retrieval unit 61 then identifies and outputs the analysis process associated with extracted schema 001 from information stored in the schema/analysis process management DB 50 in FIG. 5. Here, two analysis processes are outputted, “rank up regression analysis process for customer list” and “analysis process by sex for customer list.”

Here, the user selects “rank up regression analysis process for customer list.” At this time, the analysis process executing unit 70 executes the analysis process selected for table TB2 in the received table with schema ST2.

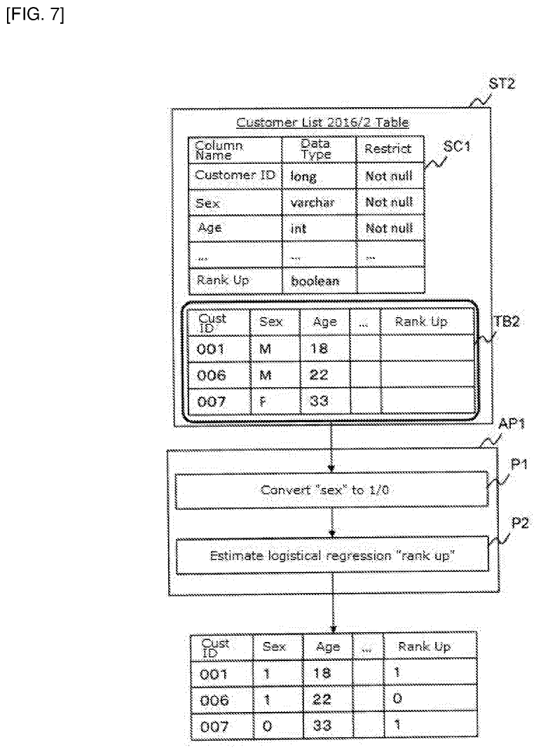

FIG. 7 is a diagram used to explain an example of processing in which an analysis process is executed. Here, analysis process AP1 is applied to table TB2. In this case, the analysis process executing unit 70 performs process P1 for converting sex data in table TB2 (process for converting M to 1 and F to 0), and executes determination process P2 using the regression formula. As a result, the values in the rank up column shown in FIG. 7 are calculated.

Note that values have not been provided in a rank up column in FIG. 6 for calculating the values in the rank up column in the example shown in FIG. 7. However, when a leading process has been defined in the analysis process, values calculated as actual data may be set in a column of the table in FIG. 6.

When an analysis process selection has been received from the user, the retrieval unit 60 (specifically the table retrieval unit 62) outputs a table. In this case, the analysis process executing unit 70 receives selection of the table desired by the user from an outputted list of tables. The analysis process executing unit 70 then executes the analysis process selected for the received table.

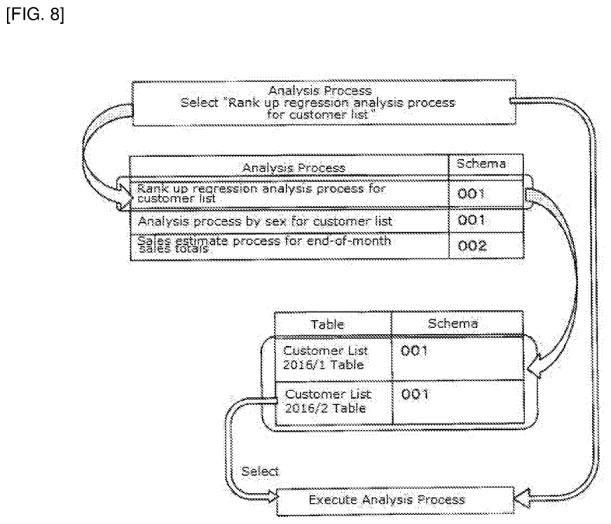

FIG. 8 is a diagram used to explain an example of processing in which a table is outputted. When the retrieval unit 60 receives “rank up regression analysis process for customer list” as the selection of analysis process from the user, the table retrieval unit 62 extracts schema 001 associated with the received analysis process from the information stored in the schema/analysis process management DB 50 in FIG. 5. The table retrieval unit 62 then identifies and outputs tables associated with the extracted schema 001 from the information stored in the table/schema management DB 30 in FIG. 3. In this case, a table including the January 2016 customer list and a table including the February 2016 customer list are outputted.

Here, the February 2016 customer list is selected by the user. The analysis process executing unit 70 then executes the selected analysis process on the received table TB2. The process used to execute the analysis process has the same details as shown in FIG. 7.

The table with schema inputting unit 10, the schema extracting unit 20, the analysis process receiving unit 40, the retrieval unit 60 (more specifically, the analysis process retrieval unit 61 and the table retrieval unit 62), and the analysis process executing unit 70 are executed by processors (central processing unit or CPU, graphics processing unit or GPU and field-programmable gate array or FPGA) operated in accordance with a program (the data analysis supporting program).

The program can be stored, for example, in a storage unit (not shown), and the processor may read this program and operate as the table with schema inputting unit 10, the schema extracting unit 20, the analysis process receiving unit 40, the retrieval unit 60 (more specifically, the analysis process retrieval unit 61 and the table retrieval unit 62), and the analysis process executing unit 70 in accordance with the program. The functions of the data analysis supporting device may also be provided in the software-as-a-service (SaaS) format.

The table with schema inputting unit 10, the schema extracting unit 20, the analysis process receiving unit 40, the retrieval unit 60 (more specifically, the analysis process retrieval unit 61 and the table retrieval unit 62), and the analysis process executing unit 70 may also be realized by dedicated software. Some or all of each configurational element in these devices may also be realized by general or dedicated circuits (circuitry), processors, or a combination of these. These may be configured on a single chip or may be configured on a plurality of chips connected by a bus. Some or all of each configurational element in these devices may also be realized by these circuits, etc. in combination with a program.

When some or all of each configurational element in the data analysis supporting device is realized by a plurality of information processing devices and circuits, the information processing devices and circuits may be centrally arranged or distributed. The information processing devices and circuits may also be realized by a client server system, cloud computing system, etc. connected to each other via a communication network.

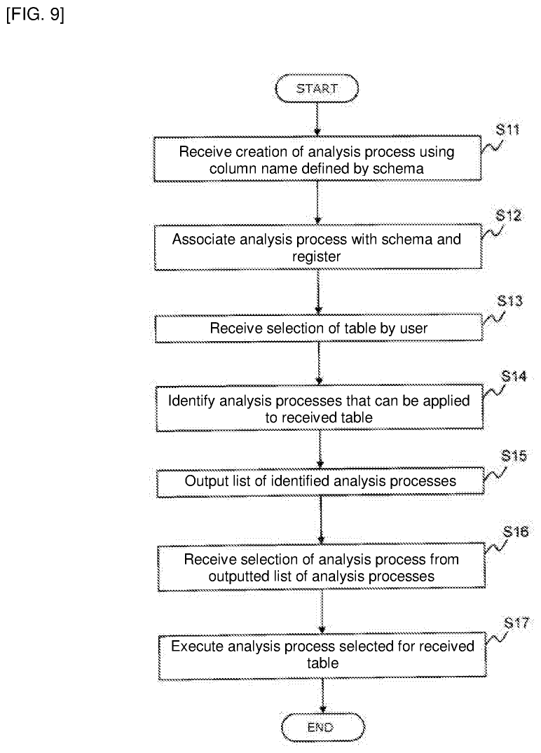

The following is an explanation of the operations performed by the data analysis supporting device in the present embodiment. FIG. 9 is a flowchart showing an example of operations for executing an analysis process using the data analysis assisting device in the first embodiment.

The analysis process receiving unit 40 receives the creation of an analysis process using a column name defined by a schema (Step S11) and registers information associating the analysis process and the schema in a schema/analysis process management DB 50 (Step S12).

When the analysis process retrieval unit 61 receives a table selection from the user (Step S13), it identifies analysis processes that can be applied to the received table on the basis of information stored in the table/schema management DB 30 and information stored in the schema/analysis process DB 50 (Step S14). The analysis process retrieval unit 61 then outputs a list of identified analysis processes (Step S15).

The analysis process executing unit 70 receives the selection of an analysis process from the outputted list of analysis processes (Step S16). The analysis process executing unit 70 then executes the analysis process selected for the received table (Step S17).

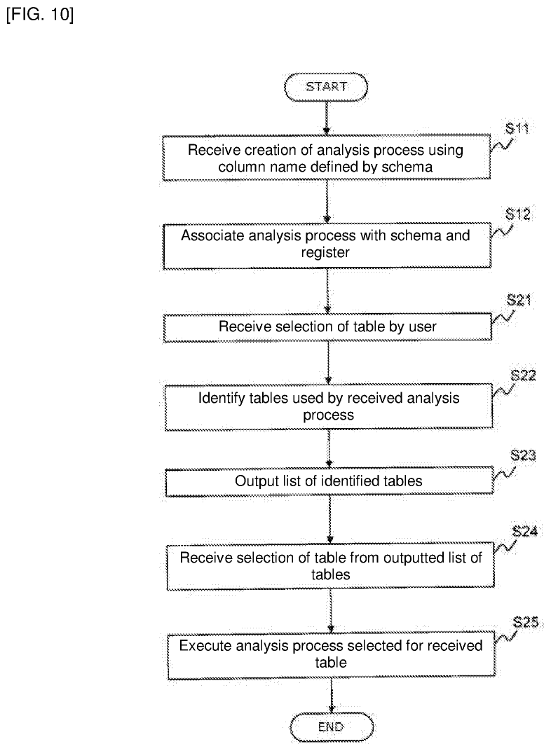

FIG. 10 is a flowchart showing another example of operations for executing an analysis process using the data analysis assisting device in the first embodiment. The processing performed by the retrieval unit 60 and the analysis process executing unit 70 in the flowchart shown in FIG. 10 differs from that of the flowchart shown in FIG. 9. The processing from Step S11 to Step S12 for registering information associating an analysis process with a schema is the same as the processing in the flowchart shown in FIG. 9.

When the table retrieval unit 62 receives an analysis process selection from the user (Step S21), it identifies tables that can be used by the received analysis process on the basis of information stored in the table/schema management DB 30 and information stored in the schema/analysis process DB 50 (Step S22). The table retrieval unit 62 then outputs a list of identified tables (Step S23).

The analysis process executing unit 70 receives the selection of a table from the outputted list of tables (Step S24). The analysis process executing unit 70 then executes the analysis process selected for the received table (Step S25).

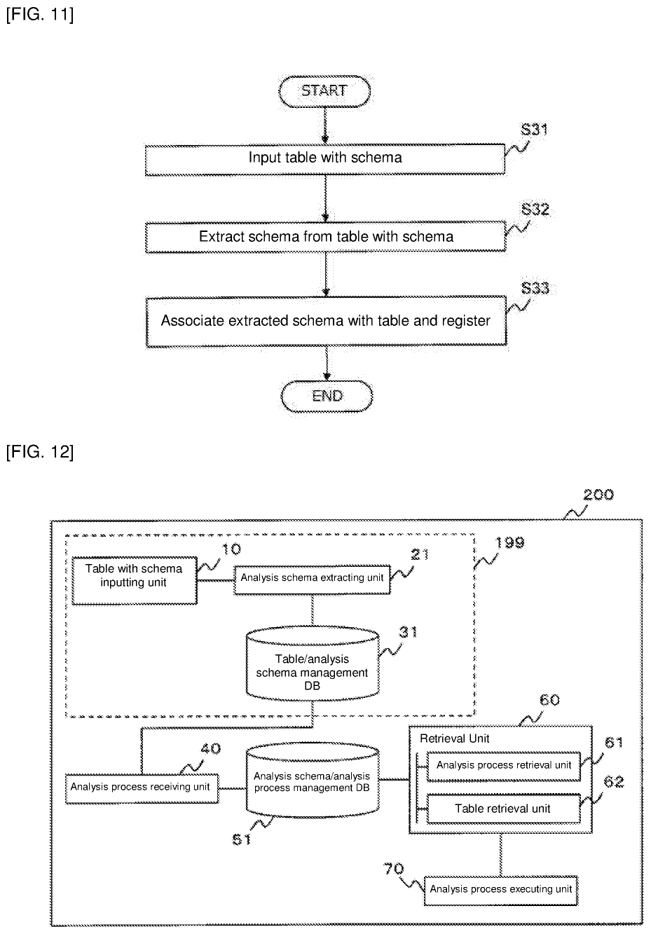

FIG. 11 is a flowchart showing an example of operations for managing a schema. When the table with schema inputting unit 10 inputs a table with schema in which a schema and a table have been associated (Step S31), the schema extracting unit 20 extracts the schema from the table with schema (Step S32). The schema extracting unit 20 then associates the extracted schema with a table and records the association in the table/schema management DB 30 (Step S33). At this time, the schema extracting unit 20 registers the extracted schema as a new schema if a schema matching the column name and the data type has not been registered in the table/schema management DB 30.

In the present embodiment, as mentioned above, the analysis process receiving unit 40 receives creation of an analysis process, and registers information in which the received analysis process has been associated with a schema that can be applied to the analysis process in the schema/analysis process management DB 50. Afterwards, when selection of a table has been received from the user, the analysis process retrieval unit 61 identifies analysis processes that can be applied to the received table on the basis of information stored in the table/schema management DB 30 and information stored in the schema/analysis process management DB 50, and outputs a list of identified analysis processes. The analysis process executing unit 70 receives the analysis process selected from the outputted list of analysis processes and executes the analysis process selected for the received table. As a result, analysis processing defined for one table can be executed on a different table.

In the present embodiment, the analysis process receiving unit 40 receives creation of an analysis process, and registers information in which the received analysis process has been associated with a schema that can be applied to the analysis process in the schema/analysis process management DB 50. Afterwards, when selection of an analysis process has been received from the user, the table retrieval unit 62 identifies tables used by the received analysis process on the basis of information stored in the table/schema management DB 30 and information stored in the schema/analysis process management DB 50, and outputs the list of identified tables. The analysis process executing unit 70 then receives selection of a table from the outputted list of tables and executes the selected analysis process on the received table. Therefore, as in the case of the method described above, analysis processing defined for one table can be executed on a different table.

In the present embodiment, the table with schema inputting unit 10 inputs a table with schema, the schema extracting unit 20 extracts the schema from the table with schema, associates the extracted schema with a table, and registers the association in the table/schema management DB 30. At this time, the schema extracting unit 20 registers the extracted schema as a new schema if a schema with matching column names and data types has not been registered in the table/schema management DB 30. Therefore, a table with schema used by general RDB can be separately managed as a schema and a table. As a result, an analysis process defined for one table can be executed on another table by defining the analysis process for a schema.

### Second Embodiment

The following is a description of the data analysis supporting device in the second embodiment of the present invention. In the explanation of the first embodiment, the schema extracting unit 20 registers an extracted schema in the table/schema management DB 30 when a schema with matching column names and data types has not been registered.

However, there are tables defined by different data types even though the columns contain the same content due to differences in versions of RDB and design changes to tables. Data types are also defined from the standpoint of RDB memory management even though the number type or string type is the same.

However, from the standpoint of data management, columns containing the same content are preferably handled as the same data type, and there are situations in which data types assumed to be for RDB are not required. Therefore, a method is explained in the present embodiment for managing analysis processes using analysis data types that are abstracted data types.

In the present embodiment, the analysis data type is an abstracted data type defined as convenient for analysis processing, and is actually separate from data types used in RDB. Specifically, analysis data types include categorical variables that represent data types that make an equivalence determination possible, numerical variables that represent a data type with continuous values, and time variables representing data types having an order relation and that can extract information representing a point on a time axis.

Specifically, numerical variables are data types representing continuous values such as real values used in regression analysis. For example, it can be a data type that can be used in operations such as basic arithmetic operations. The content included in an analysis data type is not limited to the content described above. For example, the analysis data type may include a data type representing a geographic point expressed in longitude and latitude.

FIG. 12 is a block diagram showing an example of a configuration for the data analysis assisting device in a second embodiment of the present invention. The data analysis assisting device 200 in the present embodiment includes a table with schema inputting unit 10, an analysis schema extracting unit 21, a table/analysis schema managing database 31 (table/analysis schema management DB 31 below), an analysis process receiving unit 40, an analysis schema/analysis process managing database 51 (analysis schema/analysis process management DB 51), a retrieval unit 60, and an analysis process executing unit 70.

Note that the table/analysis schema management DB 31 and the analysis schema/analysis process management DB 51 are specifically stored in, for example, a magnetic disk device.

As in the first embodiment, the table with schema inputting unit 10 inputs tables with schema.

As in the case of the schema extracting unit 20 in the first embodiment, the analysis schema extracting unit 21 extracts the schema from a table with schema. The analysis schema extracting unit 21 also converts the data type in the extracted schema to an analysis data type. The analysis schema extracting unit 21 then associates the schema with a converted data type with a table and registers the association in the table/analysis schema management DB 31. In the following description, a schema in which the data type has been converted to an analysis data type is referred to as an analysis schema.

Specifically, the analysis schema extracting unit 21 may convert the data type in the extracted schema to a predetermined analysis data type depending on the content of a column (such as column name, data type, etc.). The analysis schema extracting unit 21 may also receive an instruction from the user to convert the data type in the extracted schema to a certain analysis data type. Because analysis schema extracting unit 21 converts the data type in an extracted schema to a predetermined analysis data type in this way, it can be referred to as a data type conversion unit.

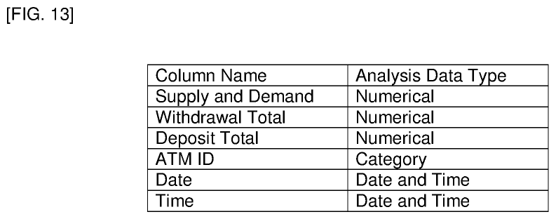

FIG. 13 is a diagram used to explain an example in which an analysis data type is set in response to the contents of a column. In the example shown in FIG. 13, the analysis data type may be predetermined for each analytical purpose. When rules have been established beforehand for converting columns to a predetermined analysis data type, the analysis schema extracting unit 21 may convert data types to analysis data types based on these established rules.

The analysis schema extracting unit 21 may combine processing operations described above. For example, conversion rules for conversion to analysis data types based on data types and column names may be established beforehand and stored in a storage unit (not shown). First, the analysis schema extracting unit 21 converts the data types in the extracted schema to analysis data types all at once in accordance with the conversion rules. Next, the analysis schema extracting unit 21 outputs the converted analysis data types based on column names and receives individual changes in analysis data type. Note that the analysis schema extracting unit 21 may receive all analysis data type changes individually. Specifically, the analysis schema extracting unit 21 may receive instructions for analysis data type conversions based on the columns in the schema, and may perform conversions of data types in the extracted schema to the received analysis data types individually.

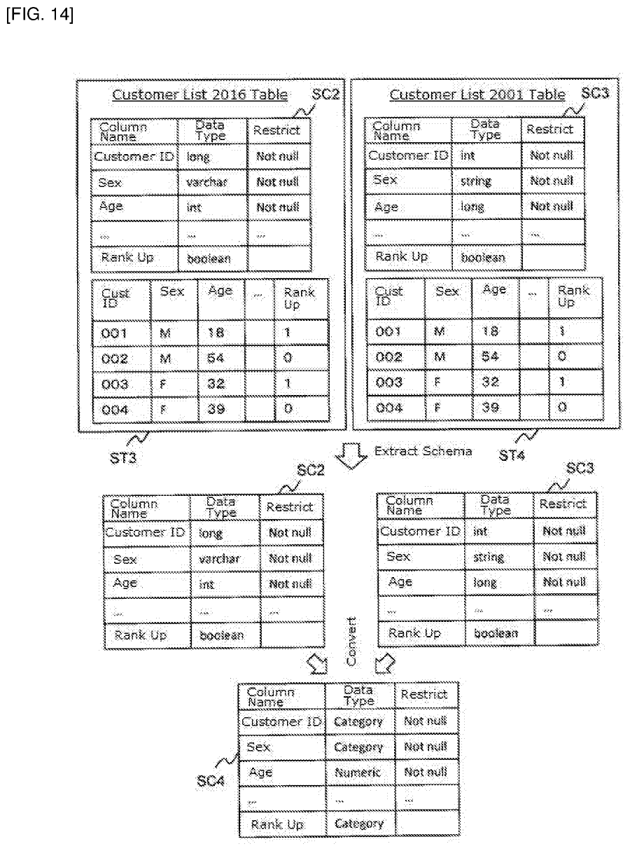

FIG. 14 is a diagram used to explain an example of processing in which an analysis schema is extracted. The two tables with schema ST3, ST4 in FIG. 14 are both tables containing customer lists but differ in terms of the schema content (specifically, data type). For example, because the customer IDs in the 2016 customer list table ST3 are expressed using numerical values, they are managed using data type “long” in RDB. Meanwhile, the customer IDs in the 2001 customer list table ST4 are also expressed using numerical values, but are managed using data type “int” in RDB due to differences in version, etc.

Customer IDs are often the subject of equivalence (non-equivalence) determination instead of the subject of a numerical calculation. Therefore, as shown in FIG. 13, the analysis schema extracting unit 21 converts to an analysis data type so that customer IDs can be analyzed as categorical values.

First, the analysis schema extracting unit 21 extracts schema SC2 and SC3 from tables with schema ST3 and ST4, respectively. The analysis schema extracting unit 21 then creates schema SC4 in which the data type in each column is converted to an analysis data type based on the conversion rules in FIG. 13.

The table/analysis schema management DB 31 associates the analysis schema with the table and stores the association. For example, the table/analysis schema management DB 31 can associate the analysis schema name with the table name and store the association. The method used by the table/analysis schema management DB 31 to store the analysis schema name with the table name and store the association is the same as that used by the table/schema management DB 30 in the first embodiment.

As in the case of the first embodiment, the analysis process receiving unit 40 receives creation of an analysis process using column names defined using an analysis schema. The analysis process receiving unit 40 then registers the created analysis process in the analysis schema/analysis process management DB 51.

The analysis schema/analysis process management DB 51 associates the analysis process with analysis schemas that can be applied to the analysis process and stores the association. The method used by the analysis schema/analysis process management DB 51 to associate the analysis process and analysis schema and store the analysis is the same as that used by the schema/analysis process management DB 50 in the first embodiment.

As in the case of the first embodiment, the retrieval unit 60 includes an analysis process retrieval unit 61 and a table retrieval unit 62. The analysis process retrieval unit 61 receives a table selection from the user. The analysis process retrieval unit 61 then extracts the analysis schema associated with the received table from information stored in the table/analysis schema management DB 31. Next, the analysis process retrieval unit 61 identifies and outputs analysis processes associated with the extracted analysis schema from information stored in the analysis schema/analysis process management DB 51.

At this time, the analysis process executing unit 70 receives the selection of the desired analysis process by the user from the outputted list of analysis processes. The analysis process executing unit 70 then executes the selected analysis process on the received table.

The table retrieval unit 62 also receives the selection of analysis process from the user. The table retrieval unit 62 extracts the analysis schema associated with the received analysis schema from information stored in the analysis schema/analysis process management DB 51. The table retrieval unit 62 then identifies and outputs the tables associated with the extracted schema from information stored in the table/analysis schema management DB 31.

At this time, the analysis process executing unit 70 receives selection of the desired table by the user from the outputted list of tables. The analysis process executing unit 70 then executes the selected analysis process on the received table.

Thus, the operations performed by the retrieval unit 60 (more specifically, the analysis process retrieval unit 61 and the table retrieval unit 62) and by the analysis process executing unit 70 are the same as those performed in the first embodiment except that the schema has been changed to an analysis schema.

Note that the table with schema inputting unit 10, the analysis schema extracting unit 21, the analysis process receiving unit 40, the retrieval unit 60 (more specifically, the analysis process retrieval unit 61 and the table retrieval unit 62), and the analysis process executing unit 70 are realized by a processor in a computer operated according to a program (data analysis assistance program). Also, as in the case of the first embodiment, the device 199 including the table with schema inputting unit 10, the analysis schema extracting unit 21, and the table/analysis schema management DB 31 can be referred to as the schema managing device. Note that, as in the first embodiment, the data analysis supporting device 200 in the present embodiment does not have to include a schema managing device. For example, an external data analysis device may be used, and the data analysis supporting device 200 may connect to the external data analysis device to obtain information.

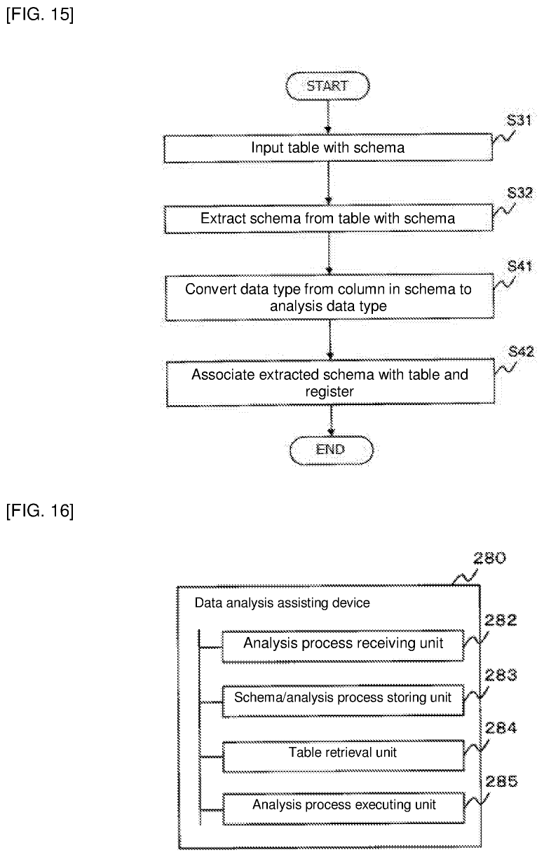

The operation of the data analysis supporting device of the present embodiment will now be explained. FIG. 15 is a flowchart showing an example of operations for managing a schema.

The process up to the extraction of the schema is the same as the process from Step S31 to Step S32 in FIG. 11.

After schema extraction, the analysis schema extracting unit 21 converts the data types of the columns in the schema to analysis schema data types (Step S41). The analysis schema extracting unit 21 associates the analysis schema with the table and registers the association in the table/analysis schema management DB 31 (Step S42).

In the present embodiment, the analysis schema extracting unit 21 converts the data types of the columns in the schema to analysis schema data types and registers information associating the schema defined by analysis data types with the table in the table/analysis schema management DB 31. Also, the analysis process receiving unit 40 registers information associating the analysis process with the schema defined by analysis data types in the analysis schema/analysis process management DB 51. Therefore, in addition to the effects of the first embodiment, the same processing can be executed using the same analysis process on tables defined by schema with different data types.

For example, data in columns including numerical information can be iteratively processed. Examples of iterative processing include “add logarithms of all numerical value type columns as a new column” and “add the monthly mean of all numerical value type columns as a new column.”

For example, supply and demand, withdrawal amounts, and deposit amounts are generally expressed as numerical value information. In RDB, supply and demand are defined using Int type data, withdrawal amounts are defined using long type data, and deposit amounts are defined using long type data. Here, the data type for withdrawal amounts and deposit amounts is the same, but the data type for supply and demand is different. Therefore, processing has to be written individually to address the data in each column.

However, in the present embodiment, the data types in the schema for a table including numerical value information in columns is converted to analysis data types. This conversion enables iterative processing to be easily written for data types conforming to the analysis. Therefore, the same analysis process can be executed on columns in which the defined data types are different.

Conversely, IDs, withdrawal amounts, and deposit amounts in automated teller machines (ATMs) are all defined using long type data. However, ID information in ATMs is usually not subject to calculations. In this case, processing generally has to be written individually because the meaning of the numerical value information is different from an analytical standpoint.

In the present embodiment, the data types in a schema are converted to analytical data types to take the meaning of each column into account. Therefore, the analysis process can distinguish meaning in columns using the same defined data type.

An overview of the present invention will now be provided. FIG. 16 is a block diagram providing an overview of the data analysis assisting device of the present invention. A data analysis assisting device 180 of the present invention (such as data analysis assisting device 100) comprises: an analysis process receiving unit 182 for receiving creation of an analysis process which is a series of processing operations for analyzing data using a column name defined by a schema to be applied to a table (such as analysis process receiving unit 40); a schema/analysis process storing unit 183 for storing information in which the received analysis process has been associated with a schema that can be applied to the received analysis process (such as schema/analysis process management DB 50); an analysis process retrieval unit 184 (such as analysis process retrieval unit 61) for identifying analysis processes that can be applied to a received table on the basis of information stored in a table/schema storing unit (such as table/schema management DB 30) for storing information in which a table has been associated with a schema to be applied to the table, and information stored in a schema/analysis process storing unit 183 when selection of a table has been received from the user, and then outputting a list of identified analysis processes; and an analysis process executing unit 185 for receiving selection of an analysis process from the outputted list, and executing the selected analysis process on the received table (such as analysis process executing unit 70).

In this configuration, an analysis process defined for one table can be executed on another table.

This data analysis assisting device 180 (such as data analysis assisting device 200) may further comprises a data type converting unit for converting the data type in a column included in a schema to an analysis data type defined as a data type to be used in analysis processing. Here, analysis data type can be a numerical value and a categorical variable representing a data type that at least makes an equivalence determination possible. The data type converting unit may register information in which a schema defined by an analysis data type has been associated with a table in the table/schema storing unit (such as table/analysis schema management DB 31), and the analysis process receiving unit 182 may register information in which an analysis process has been associated with a schema defined by an analysis data type in the schema/analysis process storing unit 183 (such as analysis schema/analysis process management DB 51).

In this configuration, the same processing using the same analysis process can be executed on tables defined by schema with different data types.

At this time, the data type converting unit may convert the data types in the extracted schema to analysis data types based on data types or column names all at once in accordance with the conversion rules.

The data type converting unit may also receive a data type conversion instruction for each column in a schema and individually convert the data types in the extracted schema to the received analysis data types.

The analysis data types may include categorical variables, numerical variables, and time variables having an order relation and representing a point on a time axis.

The present invention was explained above with reference to embodiments and examples. However, it should be noted that the present invention is not limited to these embodiments and examples. For example, it should be clear to those skilled in the art that various modifications are possible without departing from the spirit and scope of the present invention.

The present application claims priority based on U.S. Provisional Patent Application No. 62/609,768 filed on Dec. 22, 2017, which is incorporated herein by reference in its entirety.

### KEY TO THE DRAWINGS

10: Table with schema inputting unit
20: Schema extracting unit
21: Analysis schema extracting unit
30: Table/schema management DB
31: Table/analysis schema management DB
40: Analysis process receiving unit
50: Schema/analysis process management DB
51: Analysis schema/analysis process management DB
60: Retrieval unit
61: Analysis process retrieval unit
62: Table retrieval unit
70: Analysis process executing unit
99: Schema managing device
100, 200: Data analysis assisting devices

1-9. (canceled)

10. A data analysis assisting system comprising:
an analysis process receiving unit having a plurality of lines of instructions that configure a processor of the data analysis system to create an analysis process including a series of processing operations for analyzing a plurality of pieces of data in a particular table, wherein the analysis process is associated with a schema for the particular table;
a schema/analysis process storing unit having a plurality of lines of instructions that configure the processor to store a plurality of schemas including the schema for the particular table, wherein the schema for the particular table includes a column name and a data type associated with the analysis process;
an analysis process retrieval unit having a plurality of lines of instructions that configure the processor to receive a table, extract a schema for the received table, and output a list including a plurality of analysis processes that are associated with the extracted schema and can be applied to the received table, wherein the extracted schema is extracted based on a piece of information stored in a table/schema storing unit, and wherein the list is output based on a piece of information stored in the schema/analysis process storing unit that describes one or more analysis processes associated with at least one schema included in the plurality of schemas having one or more attributes in common with the extracted schema; and
an analysis process executing unit having a plurality of lines of instructions that configure the processor to receive a selection of an analysis process from the list and execute the selected analysis process on the received table.

11. The data analysis assisting system of claim 10, further comprising:
a data type converting unit having a plurality of lines of instructions that configure the processor to convert a data type included in the extracted schema to an analysis data type used in the selected analysis process, wherein the analysis data type includes a numerical value and a categorical variable representing one or more data types, wherein the numerical value and the categorical variable makes an equivalence determination between the data type in the extracted schema and the one or more data types represented by the numerical value and the categorical variable possible.

12. The data analysis assisting system of claim 11, wherein the plurality of lines of instructions included in the data type converting unit further configure the processor to register a piece of information associating the data type and the column name corresponding to the data type included in the extracted schema with the received table in the table/schema storing unit, and
the plurality of lines of instructions included in the analysis process receiving unit further configure the processor to register a piece of information associating the selected analysis process with the data type and the column name.

13. The data analysis assisting system of claim 11, wherein the extracted schema includes a plurality of data types and plurality of column names, wherein each data type and column name corresponds to a column included in the received table.

14. The data analysis assisting system of claim 13, wherein the plurality of lines of instructions included in the data type converting unit further configure the processor to convert each data type included in the plurality of data types to an analysis data type based on at least one of the plurality of data types and the plurality of column names, wherein the plurality of data types are converted into analysis data types all at once in accordance with one or more conversion rules.

15. The data analysis assisting system of claim 13, wherein the plurality of lines of instructions included in the data type converting unit further configure the processor to receive a data type conversion instruction for each column in the received table and convert the data type included in each column to an analysis data type based on the data type conversion instruction.

16. The data analysis assisting system according to claim 11, wherein the analysis data type includes a time variable having an order relation that represents a point on a time axis.

17. The data analysis assisting system according to claim 11, wherein the one or more attributes include at least one of a column name, a data type, or a restriction in the received table.

18. A data analysis assisting method comprising:
creating, by an analysis process receiving unit, an analysis process including a series of processing operations for analyzing a plurality of pieces of data included in a particular table; wherein the analysis process is associated with a schema for the particular table;
storing, in a schema/analysis process storing unit, a plurality of schemas including the schema for the particular table, wherein the schema for the particular table includes a column name and a data type associated with the analysis process;
receiving, by an analysis process retrieval unit, a table included in a tabular dataset comprising a plurality of tables, wherein each table included in the plurality of tables includes a plurality of columns and fields for storing a plurality of pieces of information;
extracting, by the analysis process retrieval unit, a schema for the table and outputting a list including a plurality of analysis processes that are associated with the extracted schema and can be applied to the received table, wherein the extracted schema is extracted based on a piece of information stored in a table/schema storing unit, and wherein the list is output based on a piece of information stored in the schema/analysis process storing unit that describes one or more analysis processes associated with at least one schema included in the plurality of schemas having one or more attributes in common with the extracted schema;
receiving, by an analysis process executing unit, a selection of an analysis process from the list; and
executing, by the analysis process executing unit, the selected analysis process on the received table.

19. A data analysis assisting method of claim 18, further comprising:
converting, by a data type converting unit, a data type included in the extracted schema to an analysis data type used in the selected analysis process, wherein the analysis data type includes a numerical value and a categorical variable representing one or more data types, wherein the numerical value and the categorical variable makes an equivalence determination between the data type in the extracted schema and the one or more data types represented by the numerical value and the categorical variable possible.

20. The data analysis assisting method of claim 19, further comprising:
registering, by the data type converting unit, a piece of information associating the data type and the column name corresponding to the data type included in the extracted schema with the received table in the table/schema storing unit, and
registering, by the analysis process receiving unit, a piece of information associating the selected analysis process with the data type and the column name.

21. The data analysis assisting method of claim 19, wherein the extracted schema includes a plurality of data types and plurality of column names, wherein each data type and column name corresponds to a column included in the received table.

22. The data analysis assisting method of claim 21, further comprising:
converting, by the data type converting unit, each data type included in the plurality of data types to an analysis data type based on at least one of the plurality of data types and the plurality of column names, wherein the plurality of data types are converted into analysis data types all at once in accordance with one or more conversion rules.

23. The data analysis assisting method of claim 21, further comprising:
receiving, by the data type converting unit, a data type conversion instruction for each column included in the extracted schema; and
converting, by the data type converting unit, the data type included in each column to an analysis data type based on the data type conversion instruction.

24. The data analysis assisting method to claim 19, wherein the analysis data type includes a time variable having an order relation that represents a point on a time axis.

25. A data analysis assisting device program that causes a processor to be configured to:
create, by an analysis process receiving unit, an analysis process including a series of processing operations for analyzing a plurality of pieces of data included in a particular table; wherein the analysis process is associated with a schema for the particular table;
store, in a schema/analysis process storing unit, a plurality of schemas including the schema for the particular table, wherein the schema for the particular table includes a column name and a data type associated with the analysis process;
receive, by an analysis process retrieval unit, a table included in a tabular dataset comprising a plurality of tables, wherein each table included in the plurality of tables includes a plurality of columns and fields for storing a plurality of pieces of information;
extract, by the analysis process retrieval unit, a schema for the table and output a list of analysis processes associated with the extracted schema, wherein the extracted schema is extracted based on a piece of information stored in a table/schema storing unit, and wherein the list is output based on a piece of information stored in the schema/analysis process storing unit that describes one or more analysis processes associated with at least one schema included in the plurality of schemas having one or more attributes in common with the extracted schema;
receive, by an analysis process executing unit, a selection of an analysis process from the list; and
execute, by the analysis process executing unit, the selected analysis process on the received table.

26. The data analysis assisting device program of claim 25, wherein the data analysis assisting device program further causes the processor to:
convert, by a data type converting unit, a data type in a column included in the extracted schema to an analysis data type used in the selected analysis process, wherein the analysis data type includes a numerical value and a categorical variable representing one or more data types, wherein the numerical value and the categorical variable makes an equivalence determination between the data type in the extracted schema and the one or more data types represented by the numerical value and the categorical variable possible.

27. The data analysis assisting device program of claim 26, wherein the data analysis assisting device program further causes the processor to:
register, by the data type converting unit, a piece of information associating the data type and the column name for the column in the extracted schema with the received table in the table/schema storing unit, and
register, by the analysis process receiving unit, a piece of information associating the selected analysis process with the data type and the column name.

28. The data analysis assisting device program of claim 26, wherein the extracted schema includes a plurality of data types and plurality of column names.

29. The data analysis assisting device program of claim 26, wherein the data analysis assisting device program further causes the processor to:
receive, by the data type converting unit, a data type conversion instruction for each column included in the extracted schema; and
convert, by the data type converting unit, the data type included in each column to an analysis data type based on the data type conversion instruction.
